(19) United States
(12) Patent Application Publication
(10) Pub. No.: US 2017/0171301 A1
(43) Pub. Date: Jun. 15, 2017

(54) METHOD, DEVICE AND SYSTEM FOR LOAD BALANCING CONFIGURATION

(71) Applicants: Le Holdings (Beijing) Co., Ltd., Beijing (CN); LeCloud Computing Co., Ltd., Beijing (CN)

(72) Inventors: Chao LI, Beijing (CN); Jie ZHANG, Beijing (CN)

(21) Appl. No.: 15/246,523

(22) Filed: Aug. 24, 2016

Related U.S. Application Data
(63) Continuation of application No. PCT/CN2016/088866, filed on Jul. 6, 2016.

(30) Foreign Application Priority Data
Dec. 11, 2015 (CN) 201510921238.2

(51) Int. Cl. H04L 29/08

(52) U.S. Cl. CPC H04L 67/1002; H04L 67/34; H04L 67/2819; H04L 67/20

(57) ABSTRACT

Disclosed are a method, a device and a system for load balancing configuration. The method includes: receiving load balancing configuration information input via an operation interface; determining whether the load balancing configuration information meets a preset condition; if the load balancing configuration information meets the preset condition, generating a load balancing configuration file according to the load balancing configuration information; and sending the load balancing configuration file to a proxy server, so that the proxy server instructs a load balancing server, which is to be configured, to load the load balancing configuration file.

### CROSS REFERENCE TO RELATED APPLICATIONS

This application is a continuation of International Application No. PCT/CN2016/088866, filed on Jul. 6, 2016, which is based upon and claims priority to Chinese Patent Application No. 201510921238.2, filed on Dec. 11, 2015, the entire contents of which are incorporated herein by reference.

### TECHNICAL FIELD

The present disclosure relates to information technologies, and more particularly, to a method, a device and a system for load balancing configuration.

### BACKGROUND

With continuous developments of Internet technologies and increase in service quality, network visits and data traffics have been increased so much, and thus using a single server device cannot bear a huge number of network services. In this context, load balancing technologies emerge. By using such technologies, a plurality of servers share network services, for example, a plurality of web servers, FTP servers, enterprise critical application servers and other mission-critical servers. Before sharing of network services among a plurality of servers, it is needed to configure a load balancing function for the servers.

At present, professionals write underlying load balancing configuration files according to load balancing configuration information to perform load balancing configuration. However, before writing the underlying load balancing configuration files according to load balancing configuration information, professionals need to learn and master syntax and related knowledge for writing the load balancing configuration files, which results in high costs and thereby low efficiency in load balancing configuration. In addition, if there are a plurality of servers, load balancing configuration needs to be performed for many times. As a result, the load balancing configuration is slow and errors are easy to occur, and thereby such load balancing configuration method leads to low efficiency and accuracy.

### SUMMARY

The present disclosure provides a method, a device and a system for load balancing configuration so as to solve the problem of low efficiency and accuracy in load balancing configuration in conventional technologies.

In a first aspect, embodiments of the present disclosure provide a method for load balancing configuration, implemented by a client, including:

receiving load balancing configuration information input via an operation interface;

determining whether the load balancing configuration information meets a preset condition;

if the load balancing configuration information meets the preset condition, generating a load balancing configuration file according to the load balancing configuration information; and

sending the load balancing configuration file to a proxy server, so that the proxy server instructs a load balancing server, which is to be configured, to load the load balancing configuration file.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for load balancing configuration mentioned by embodiments of the present disclosure.

In a third aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to:

receive a load balancing configuration file sent from a client, wherein the load balancing configuration file is a configuration file generated by the client according to load balancing configuration information input via an operation interface; and

send the load balancing configuration file to a load balancing server which is to be configured and instructing the load balancing server to load the load balancing configuration file.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for load balancing configuration in accordance with some embodiments.

FIG. 2 is a flow chart of another method for load balancing configuration in accordance with some embodiments.

FIG. 3 is a flow chart of another method for load balancing configuration in accordance with some embodiments.

FIG. 4 is a flow chart of another method for load balancing configuration in accordance with some embodiments.

FIG. 5 is a block diagram of a client in accordance with some embodiments.

FIG. 6 is a block diagram of another client in accordance with some embodiments.

FIG. 7 is a block diagram of a server in accordance with some embodiments.

FIG. 8 is a block diagram of another server in accordance with some embodiments.

FIG. 9 is a block diagram of a system for load balancing configuration in accordance with some embodiments.

FIG. 10 is a block diagram showing a physical structure of a server in accordance with some embodiments.

FIG. 11 is a block diagram of an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with reference to drawings of embodiments of the present disclosure. It should be noted that the following embodiments are illustrative only, rather than limiting the scope of the disclosure.

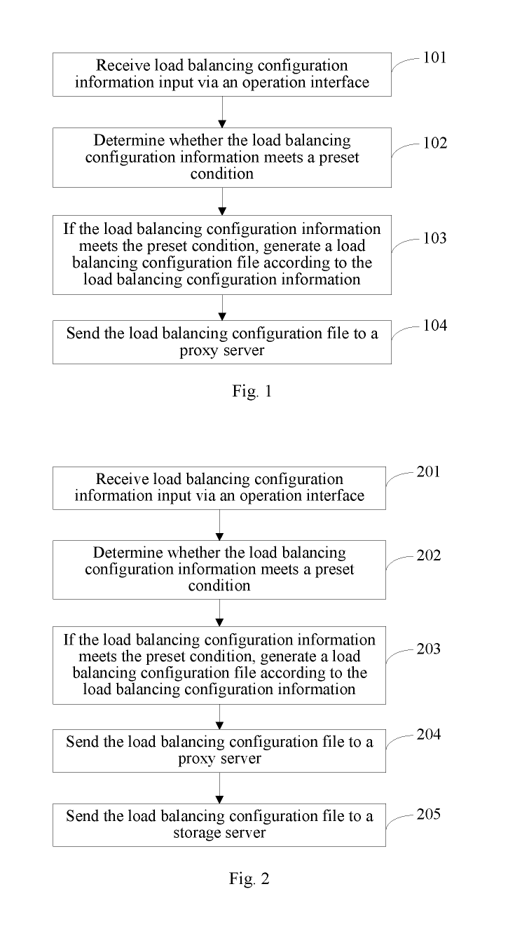

An embodiment of the present disclosure provides a method for load balancing configuration, which can be applied a client. As shown in FIG. 1, the method can include the following steps.

In 101, a client receives load balancing configuration information input via an operation interface.

For example, the load balancing configuration information may include identification information of a load balancing server which is to be configured and a weight value for load balancing. The identification information of the load balancing server which is to be configured can be a combination of the IP (Internet Protocol) address and the port number of the load balancing server, or the name of the load balancing server, and embodiments of the present disclosure do not impose specific limitations on this. For example, the identification information of the load balancing server to be configured can be 192.168.5.126:80, and the weight value for load balancing can be 3.

The load balancing configuration information input through the operation interface can be load balancing configuration information which is directly input through the operation interface by a user, or load balancing configuration information sent from a third party through the operation interface. By setting and opening the operation interface, even common users can configure load balancing, and thus the work costs consumed by maintenance professionals for load balancing configuration can be saved.

In 102, the client determines whether the load balancing configuration information meets a preset condition.

The preset condition can be set according to users' demands, or may be set according to a default mode of the system, and embodiments of the present disclosure do not impose specific limitations on this.

It should be noted that when the load balancing configuration information is the identification information of the load balancing server to be configured, the preset condition can be preset identification information. For example, if the IP addresses of servers in a cluster providing network services are: 192.168.5.1: 80-192.168.5.126: 65535, then the preset identification information can be any one of 192.168.5.1: 80-192.168.5.126: 65535. If the IP address of the load balancing server to be configured which is input through the operation interface is 192.168.5.1: 70, it can be determined that the identification information of the load balancing server to be configured is not in conformity with the preset identification information.

When the load balancing configuration information is the weight value for load balancing, the preset condition can be a preset weight threshold. For example, if the preset weight threshold is a range, [1-10] and the weight value input through the operation interface is 8, it can be determined that the weight value for load balancing is in conformity with the preset weight threshold.

In 103, if the load balancing configuration information meets the preset condition, the client generates a load balancing configuration file according to the load balancing configuration information.

In the embodiment of the present disclosure, a load balancing configuration file is generated according to the load balancing configuration information input through the operation interface, thereby avoiding manual writing of the load balancing configuration file, reducing the costs for professionals to learn and master syntax and related knowledge for writing the load balancing configuration file, and increasing efficiency for load balancing configuration.

In 104, the client sends the load balancing configuration file to a proxy server.

Then, the proxy server can instruct the load balancing server, which is to be configured, to load the load balancing configuration file.

In the embodiment of the present disclosure, after receiving the load balancing configuration file, the proxy server can send the load balancing configuration file to the load balancing server to be configured, and then call preset commands to instruct the load balancing server to be configured to load the load balancing configuration file. The preset commands can be commands for instructing the load balancing server to be configured to shut down and restart. After shutdown and restart, the load balancing server to be configured to can load the load balancing configuration file.

In the embodiment of the present disclosure, the proxy server instructs the load balancing server, which is to be configured, to load the load balancing configuration file, and this can increase the speed for load balancing configuration, and thereby increase efficiency for load balancing configuration. In addition, this can avoid errors which may occur when professionals configure load balancing repeatedly, and thereby increase accuracy for load balancing configuration.

In the method for load balancing configuration provided by embodiments of the present disclosure, a load balancing configuration file is generated according to load balancing configuration information input via an operation interface, and then the load balancing configuration file is sent to a proxy server, so that the proxy server instructs a load balancing server, which is to be configured, to load the load balancing configuration file. As compared with conventional technologies in which professionals write underlying load balancing configuration files according to load balancing configuration information to perform load balancing configuration, the technical solutions in the present disclosure can realize automatic load balancing configuration, and thus can increase efficiency and accuracy in load balancing configuration.

An embodiment of the present disclosure provides another method for load balancing configuration, which can be applied a client. As shown in FIG. 2, the method can include the following steps.

In 201, a client receives load balancing configuration information input via an operation interface.

In the embodiment of the present disclosure, step 201 can include: receiving the load balancing configuration information directly input through the operation interface; or receiving the load balancing configuration information sent from a third party through the operation interface.

In 202, the client determines whether the load balancing configuration information meets a preset condition.

For example, the load balancing configuration information can include identification information of the load balancing server which is to be configured and a weight value for load balancing. Step 202 can include determining whether the identification information is in conformity with preset identification information and whether the weight value is in conformity with a preset weight threshold.

In 203, if the load balancing configuration information meets the preset condition, the client generates a load balancing configuration file according to the load balancing configuration information.

In 204, the client sends the load balancing configuration file to a proxy server.

Then, the proxy server can instruct the load balancing server, which is to be configured, to load the load balancing configuration file.

In 205, the client sends the load balancing configuration file to a storage server.

Then, when determining that there is an update in the load balancing configuration file, the storage server can notify the proxy server to obtain the updated load balancing configuration file and instruct the load balancing server, which is to be configured, to load the updated load balancing configuration file.

In the embodiment, when determining that there is an update in the load balancing configuration file, the storage server can send notification information to the proxy server. After receiving the notification information, the proxy server obtains the updated load balancing configuration file and instructs the load balancing server, which is to be configured, to load the updated load balancing configuration file. In addition, after receiving the notification information, the updated load balancing configuration file can be synched with other servers in the same group as the load balancing to be configured, so as to further increase efficiency for load balancing configuration.

It should be noted that the proxy server and the load balancing server to be configured can be installed on the same server; after receiving the notification information, the proxy server can directly store the updated load balancing configuration file under a local load balancing configuration file directory, and then instruct the load balancing configuration server to be configured to reload the load balancing configuration file.

In the embodiment of the present, the load balancing configuration file is sent to the storage server, and when the storage server determines that there is an update in the load balancing configuration file, the proxy server instructs the load balancing server to be configured to load the load balancing configuration file. This can avoid repeated configuration of load balancing, and thereby reduce system resource consumption for load balancing configuration.

In the method for load balancing configuration provided by embodiments of the present disclosure, a load balancing configuration file is generated according to load balancing configuration information input via an operation interface, and then the load balancing configuration file is sent to a proxy server, so that the proxy server instructs a load balancing server, which is to be configured, to load the load balancing configuration file. As compared with conventional technologies in which professionals write underlying load balancing configuration files according to load balancing configuration information to perform load balancing configuration, the technical solutions in the present disclosure can realize automatic load balancing configuration, and thus can increase efficiency and accuracy in load balancing configuration.

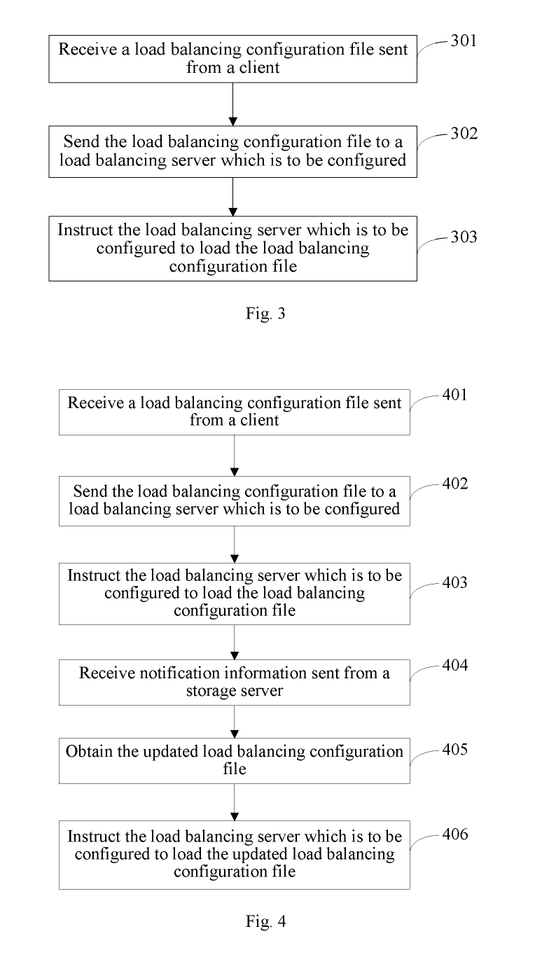

An embodiment of the present disclosure provides another method for load balancing configuration, which can be applied in a proxy server. As shown in FIG. 3, the method can include the following steps.

In 301, a proxy server receives a load balancing configuration file sent from a client.

The load balancing configuration file is a configuration file generated by the client according to load balancing configuration information input via an operation interface.

The load balancing configuration information input through the operation interface can be load balancing configuration information which is directly input through the operation interface by a user, or load balancing configuration information sent from a third party through the operation interface.

In 302, the proxy server sends the load balancing configuration file to a load balancing server to be configured.

In 303, the proxy server instructs the load balancing server to be configured to load the load balancing configuration file.

In the method for load balancing configuration provided by embodiments of the present disclosure, a load balancing configuration file is generated according to load balancing configuration information input via an operation interface, and then the load balancing configuration file is sent to a proxy server, so that the proxy server instructs a load balancing server, which is to be configured, to load the load balancing configuration file. As compared with conventional technologies in which professionals write underlying load balancing configuration files according to load balancing configuration information to perform load balancing configuration, the technical solutions in the present disclosure can realize automatic load balancing configuration, and thus can increase efficiency and accuracy in load balancing configuration.

An embodiment of the present disclosure provides another method for load balancing configuration, which can be applied in a proxy server. As shown in FIG. 4, the method can include the following steps.

In 401, a proxy server receives a load balancing configuration file sent from a client.

The load balancing configuration file is a configuration file generated by the client according to load balancing configuration information input via an operation interface.

In 402, the proxy server sends the load balancing configuration file to a load balancing server to be configured.

In 403, the proxy server instructs the load balancing server to be configured to load the load balancing configuration file.

In 404, the proxy server receives notification information sent from a storage server.

The notification information is configured to notify the proxy server that there is an update in the load balancing configuration file sent from the client.

In 405, the proxy server obtains the updated load balancing configuration file.

In 406, the proxy server instructs the load balancing server to be configured to load the updated load balancing configuration file.

In the method for load balancing configuration provided by embodiments of the present disclosure, a load balancing configuration file is generated according to load balancing configuration information input via an operation interface, and then the load balancing configuration file is sent to a proxy server, so that the proxy server instructs a load balancing server, which is to be configured, to load the load balancing configuration file. As compared with conventional technologies in which professionals write underlying load balancing configuration files according to load balancing configuration information to perform load balancing configuration, the technical solutions in the present disclosure can realize automatic load balancing configuration, and thus can increase efficiency and accuracy in load balancing configuration.

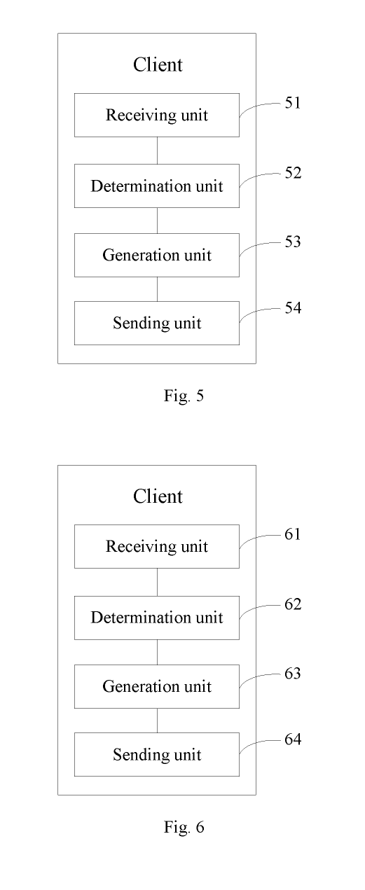

Further, an embodiment of the present disclosure provides a client to implement the above method described in connection with FIG. 1. As shown in FIG. 5, the client can include a receiving unit 51, a determination unit 52, a generation unit 53 and a sending unit 54.

The receiving unit 51 is configured to receive load balancing configuration information input via an operation interface. For example, the load balancing configuration information can include identification information of a load balancing server which is to be configured and a weight value for load balancing. The receiving unit 51 is a main functional module in the client for receiving the load balancing configuration information input through the operation interface.

The determination unit 52 is configured to determine whether the load balancing configuration information meets a preset condition. The determination unit 52 is a main functional module in the client for determining whether the load balancing configuration information meets the preset condition.

The generation unit 53 is configured to, if it is determined that the load balancing configuration information meets the preset condition, generate a load balancing configuration file according to the load balancing configuration information. The generation unit 53 is a main functional module in the client for generating the load balancing configuration file.

The sending unit 54 is configured to send the load balancing configuration file to a proxy server. The sending unit 54 is a main functional module in the client for sending the load balancing configuration file.

Then, the proxy server can instruct a load balancing server, which is to be configured, to load the load balancing configuration file.

It should be noted that the above descriptions regarding the method described in connection with FIG. 1 can also apply to respective functional units in the client provided by embodiments of the present disclosure, and thus repeated descriptions are omitted here. Related functional modules in embodiments of the present disclosure can be implemented by hardware processors.

In the client provided by embodiments of the present disclosure, a load balancing configuration file is generated according to load balancing configuration information input via an operation interface, and then the load balancing configuration file is sent to a proxy server, so that the proxy server instructs a load balancing server, which is to be configured, to load the load balancing configuration file. As compared with conventional technologies in which professionals write underlying load balancing configuration files according to load balancing configuration information to perform load balancing configuration, the technical solutions in the present disclosure can realize automatic load balancing configuration, and thus can increase efficiency and accuracy in load balancing configuration.

Further, an embodiment of the present disclosure provides another client to implement the method described in connection with FIG. 2. As shown in FIG. 6, the client can include a receiving unit 61, a determination unit 62, a generation unit 63 and a sending unit 64.

The receiving unit 61 is configured to receive load balancing configuration information input via an operation interface.

The determination unit 62 is configured to determine whether the load balancing configuration information meets a preset condition.

The generation unit 63 is configured to, if it is determined that the load balancing configuration information meets the preset condition, generate a load balancing configuration file according to the load balancing configuration information.

The sending unit 64 is configured to send the load balancing configuration file to a proxy server.

Then, the proxy server can instruct a load balancing server, which is to be configured, to load the load balancing configuration file.

The receiving unit 61 is configured to receive the load balancing configuration information directly input through the operation interface, or receive the load balancing configuration information sent from a third party through the operation interface.

The load balancing configuration information can include identification information of the load balancing server which is to be configured and a weight value for load balancing.

The determination unit 62 is configured to determine whether the identification information is in conformity with preset identification information and whether the weight value is in conformity with a preset weight threshold.

The sending unit 64 is further configured to send the load balancing configuration file to a storage server, so that, when determining that there is an update in the load balancing configuration file, the storage server notifies the proxy server to obtain the updated load balancing configuration file and instructs the load balancing server, which is to be configured, to load the updated load balancing configuration file.

It should be noted that the above descriptions regarding the method described in connection with FIG. 2 can also apply to respective functional units in the client provided by embodiments of the present disclosure, and thus repeated descriptions are omitted here. Related functional modules in embodiments of the present disclosure can be implemented by hardware processors.

In the client provided by embodiments of the present disclosure, a load balancing configuration file is generated according to load balancing configuration information input via an operation interface, and then the load balancing configuration file is sent to a proxy server, so that the proxy server instructs a load balancing server, which is to be configured, to load the load balancing configuration file. As compared with conventional technologies in which professionals write underlying load balancing configuration files according to load balancing configuration information to perform load balancing configuration, the technical solutions in the present disclosure can realize automatic load balancing configuration, and thus can increase efficiency and accuracy in load balancing configuration.

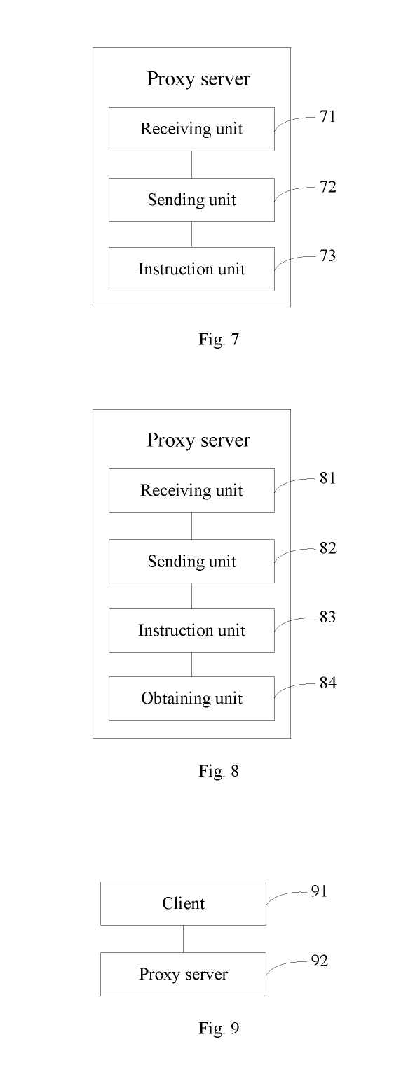

Further, an embodiment of the present disclosure provides a proxy server to implement the method described in connection with FIG. 3. As shown in FIG. 7, the proxy server can include a receiving unit 71, a sending unit 72 and an instruction unit 73.

The receiving unit 71 is configured to receive a load balancing configuration file sent from a client. The load balancing configuration file is a configuration file generated by the client according to load balancing configuration information input via an operation interface. The receiving unit 71 is a main functional module in the proxy server for receiving the load balancing configuration file.

The sending unit 72 is configured to send the load balancing configuration file to a load balancing server which is to be configured. The sending unit 72 is a main functional module in the proxy server for sending the load balancing configuration file.

The instruction unit 73 is configured to instruct the load balancing server to load the load balancing configuration file. The sending unit 73 is a main functional module in the proxy server for instructing load balancing server, which is to be configured, to load the load balancing configuration file.

It should be noted that the above descriptions regarding the method described in connection with FIG. 3 can also apply to respective functional units in the proxy server provided by embodiments of the present disclosure, and thus repeated descriptions are omitted here. Related functional modules in embodiments of the present disclosure can be implemented by hardware processors.

In the server provided by embodiments of the present disclosure, a load balancing configuration file is generated according to load balancing configuration information input via an operation interface, and then the load balancing configuration file is sent to a proxy server, so that the proxy server instructs a load balancing server, which is to be configured, to load the load balancing configuration file. As compared with conventional technologies in which professionals write underlying load balancing configuration files according to load balancing configuration information to perform load balancing configuration, the technical solutions in the present disclosure can realize automatic load balancing configuration, and thus can increase efficiency and accuracy in load balancing configuration.

Further, an embodiment of the present disclosure provides a proxy server to implement the method described in connection with FIG. 4. As shown in FIG. 8, the proxy server can include the proxy server can include a receiving unit 81, a sending unit 82 and an instruction unit 83.

The receiving unit 81 is configured to receive a load balancing configuration file sent from a client. The load balancing configuration file is a configuration file generated by the client according to load balancing configuration information input via an operation interface.

The sending unit 82 is configured to send the load balancing configuration file to a load balancing server which is to be configured.

The instruction unit 83 is configured to instruct the load balancing server to load the load balancing configuration file.

The proxy server can further include an obtaining unit 84.

The receiving unit 81 is further configured to receive notification information sent from a storage server. The notification information is configured to notify the proxy server that there is an update in the load balancing configuration file sent from the client.

The obtaining unit 84 is configured to obtain the updated load balancing configuration file. The obtaining unit 84 is a main functional module in the proxy server for obtaining the updated load balancing configuration file.

The instruction unit 83 is configured to instruct the load balancing server, which is to be configured, to load the updated load balancing configuration file.

It should be noted that the above descriptions regarding the method described in connection with FIG. 4 can also apply to respective functional units in the proxy server provided by embodiments of the present disclosure, and thus repeated descriptions are omitted here. Related functional modules in embodiments of the present disclosure can be implemented by hardware processors.

In the server provided by embodiments of the present disclosure, a load balancing configuration file is generated according to load balancing configuration information input via an operation interface, and then the load balancing configuration file is sent to a proxy server, so that the proxy server instructs a load balancing server, which is to be configured, to load the load balancing configuration file. As compared with conventional technologies in which professionals write underlying load balancing configuration files according to load balancing configuration information to perform load balancing configuration, the technical solutions in the present disclosure can realize automatic load balancing configuration, and thus can increase efficiency and accuracy in load balancing configuration.

An embodiment of the present disclosure provides a system for load balancing configuration. As shown in FIG. 9, the system can include a client 91 and a proxy server 92.

The client 91 is configured to: receive load balancing configuration information input via an operation interface; determine whether the load balancing configuration information meets a preset condition; if the load balancing configuration information meets the preset condition, generate a load balancing configuration file according to the load balancing configuration information; and send the load balancing configuration file to the proxy server 92.

The proxy server 92 is configured to: send the load balancing configuration file to a load balancing server which is to be configured and instruct the load balancing server to load the load balancing configuration file.

It should be noted that the functions of respective units or modules in the above clients, proxy servers and system for load balancing configuration according to embodiments of the present disclosure can be implemented by hardware processors.

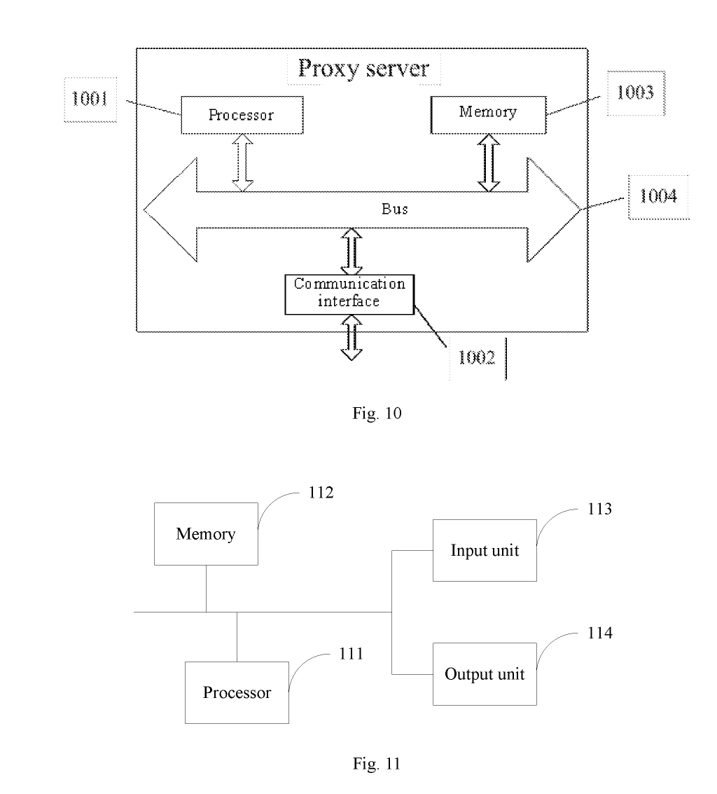

As an example, FIG. 10 is a block diagram showing a physical structure of a server in accordance with an embodiment of the present disclosure. The server can include a processor 1001, a communication interface 1002, a memory 1003 and a bus 1004. The processor 1001, the communication interface 1002 and the memory 1003 communicate with each other via the bus 1004. The communication interface 1002 may be used for information transmission between the server and a client. The processor 1001 calls logic instructions in the memory 1003 to perform the following method: receiving load balancing configuration information input via an operation interface; determining whether the load balancing configuration information meets a preset condition; if the load balancing configuration information meets the preset condition, generating a load balancing configuration file according to the load balancing configuration information; and sending the load balancing configuration file to a proxy server, so that the proxy server instructs a load balancing server, which is to be configured, to load the load balancing configuration file.

In addition, the logic instructions in the memory 1003 may be implemented as software functional units which can be stored in a computer readable storage medium when sold or used as independent products. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

In the system for load balancing configuration provided by embodiments of the present disclosure, a load balancing configuration file is generated according to load balancing configuration information input via an operation interface, and then the load balancing configuration file is sent to a proxy server, so that the proxy server instructs a load balancing server, which is to be configured, to load the load balancing configuration file. As compared with conventional technologies in which professionals write underlying load balancing configuration files according to load balancing configuration information to perform load balancing configuration, the technical solutions in the present disclosure can realize automatic load balancing configuration, and thus can increase efficiency and accuracy in load balancing configuration.

Further, an embodiment of the present disclosure further provides a non-transitory computer-readable storage medium storing executable instructions, which can be executed by an electronic device to perform any methods for load balancing configuration mentioned by embodiments of the present disclosure.

FIG. 11 is a block diagram of an electronic device which is configured to perform the methods for load balancing configuration according to an embodiment of the present disclosure. As shown in FIG. 11, the device includes: one or more processors 111 and memory 112. A processor 111 is showed in FIG. 11 for an example.

Device which is configured to perform the methods for load balancing configuration can also include: input unit 113 and output unit 114.

Processor 111, memory 112, input unit 113 and output unit 114 can be connected by BUS or other methods, and BUS connecting is showed in FIG. 11 for an example.

Memory 112 can be used for storing non-transitory software program, non-transitory computer executable program and modules as a non-transitory computer-readable storage medium, such as corresponding program instructions/modules for the methods for load balancing configuration mentioned by embodiments of the present disclosure (such as shown in FIG. 5, receiving unit 51, determination unit 52, generation unit 53 and sending unit 54). Processor 111 performs kinds of functions and load balancing configuration of the electronic device by executing non-transitory software program, instructions and modules which are stored in memory 112, thereby realizes the methods for load balancing configuration mentioned by embodiments of the present disclosure.

Memory 112 can include program storage area and data storage area, thereby the operating system and applications required by at least one function can be stored in program storage area and data created by using the device for load balancing configuration can be stored in data storage area. Furthermore, memory 112 can include high speed Random-access memory (RAM) or non-volatile memory such as magnetic disk storage device, flash memory device or other non-volatile solid state storage devices. In some embodiments, memory 112 can include long-distance setup memories relative to processor 111, which can communicate with the device for load balancing configuration by networks. The examples of said networks are including but not limited to Internet, Intranet, LAN, mobile Internet and their combinations.

Input unit 113 can be used to receive inputted number, character information and key signals causing user configures and function controls of the device for load balancing configuration. Output unit 114 can include a display screen or a display device.

The said module or modules are stored in memory 112 and perform the methods for load balancing configuration when executed by one or more processors 111.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for load balancing configuration, implemented by a client, comprising:
receiving load balancing configuration information input via an operation interface;
determining whether the load balancing configuration information meets a preset condition;
if the load balancing configuration information meets the preset condition, generating a load balancing configuration file according to the load balancing configuration information; and
sending the load balancing configuration file to a proxy server, so that the proxy server instructs a load balancing server, which is to be configured, to load the load balancing configuration file.

2. The method according to claim 1, wherein the receiving of the load balancing configuration information input through the operation interface comprises:
receiving the load balancing configuration information directly input through the operation interface; or
receiving the load balancing configuration information sent from a third party through the operation interface.

3. The method according to claim 1, wherein the load balancing configuration information comprises identification information of the load balancing server which is to be configured and a weight value for load balancing;
wherein the determining of whether the load balancing configuration information meets a preset condition, comprises:
determining whether the identification information is in conformity with preset identification information and whether the weight value is in conformity with a preset weight threshold.

4. The method according to claim 1, further comprising:
sending the load balancing configuration file to a storage server, so that, when determining that there is an update in the load balancing configuration file, the storage server notifies the proxy server to obtain the updated load balancing configuration file and instructs the load balancing server, which is to be configured, to load the updated load balancing configuration file.

5. An electronic device, comprising:
at least one processor; and
a memory communicably connected with the at least one processor for storing instructions executable by the at least one processor, wherein execution of the instructions by the at least one processor causes the at least one processor to:
receive load balancing configuration information input via an operation interface;
determine whether the load balancing configuration information meets a preset condition;
if the load balancing configuration information meets the preset condition, generate a load balancing configuration file according to the load balancing configuration information; and
send the load balancing configuration file to a proxy server, so that the proxy server instructs a load balancing server, which is to be configured, to load the load balancing configuration file.

6. The electronic device according to claim 5, wherein the receiving of the load balancing configuration information input through the operation interface comprises:
receiving the load balancing configuration information directly input through the operation interface; or
receiving the load balancing configuration information sent from a third party through the operation interface.

7. The electronic device according to claim 5, wherein the load balancing configuration information comprises identification information of the load balancing server which is to be configured and a weight value for load balancing;
wherein the determining of whether the load balancing configuration information meets a preset condition, comprises:
determining whether the identification information is in conformity with preset identification information and whether the weight value is in conformity with a preset weight threshold.

8. The electronic device according to claim 5, wherein the instructions are executed to cause the at least one processor to:
send the load balancing configuration file to a storage server, so that, when determining that there is an update in the load balancing configuration file, the storage server notifies the proxy server to obtain the updated load balancing configuration file and instructs the load balancing server, which is to be configured, to load the updated load balancing configuration file.

9. An electronic device, comprising:
at least one processor; and
a memory communicably connected with the at least one processor for storing instructions executable by the at least one processor, wherein execution of the instructions by the at least one processor causes the at least one processor to:
receive a load balancing configuration file sent from a client, wherein the load balancing configuration file is a configuration file generated by the client according to load balancing configuration information input via an operation interface; and
send the load balancing configuration file to a load balancing server which is to be configured and instructing the load balancing server to load the load balancing configuration file.

10. The electronic device according to claim 9, wherein the instructions are executed to cause the at least one processor to:
receive notification information sent from a storage server, wherein the notification information is configured to notify a proxy server that there is an update in the load balancing configuration file sent from the client; and
obtain the updated load balancing configuration file;
wherein the instructing the load balancing server to load the load balancing configuration file comprises:
instructing the load balancing server to load the updated load balancing configuration file.
